(19) United States
(12) Patent Application Publication
(10) Pub. No.: US 2005/0197868 A1
(43) Pub. Date: Sep. 8, 2005

(54) Method and device for representing a process flow

(76) Inventor: Paul Girbig, Uttenreuth (DE)

Correspondence Address: Siemens Corporation;Intellectual Property Department, 170 Wood Avenue South, Iselin, NJ, 08830, US

(21) Appl. No.: 10/511,283

(22) PCT Filed: Mar. 31, 2003
(86) PCT No.: PCT/DE03/01053

§ 371 Date: Oct. 12, 2004

(30) Foreign Application Priority Data
Apr. 12, 2002 (DE) 102 16 385.5

(51) Int. Cl. G06F 17/60

(52) U.S. Cl. 705/7

(57) ABSTRACT

The invention relates to a method and device for representing a process flow. According to the invention, an optimal process flow is represented by means of an optimal point and the actual values of the variables of the processes are represented as points which are respectively arranged at a distance from the optimal point. The distances are determined by means of a good functional.

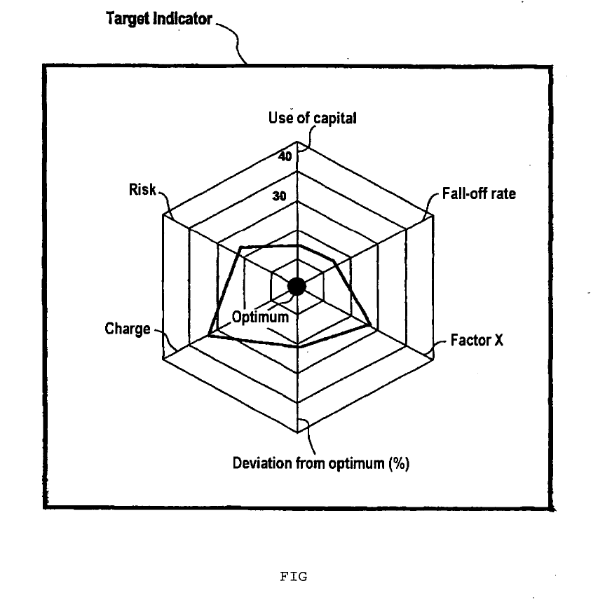

In the prior art, it is frequently the case that only processed information present as variables and measured quantities on paper or EDP is available for controlling a process flow.

Information that places the process development, e.g. for the coming 24 hours or for longer periods if required, in relation to an ideal process flow (bench mark) and that can be directly generated in short periods from process flows, is not known.

The object of the invention is therefore to provide a method and a device for improving the control of a process flow.

The object is achieved in accordance with the invention by the features of claim 1 and claim 2.

For machines, the term delta consideration of the current operating point compared with an optimum operating point is frequently used in the context of monitoring the process flow of the machines.

A similar approach can also be used for business processes to take account of the characteristic and/or operating variables peculiar to a business process.

The invention should provide managers or directors of businesses with up-to-date information which is arithmetically determined and visually processed and which indicates deviations between their current business operating point and an optimum operating point. The invention comprises virtually a “measuring device”, that by means of a graphic display (e.g. a “spider image”) represents the arithmetically determined deviation from an ideal operating point of their business process, or in the final analysis deviations from the optimum business point are displayed (e.g. a deviation between expected optimum operation and forecast values, provided no actions bringing about changes are undertaken or planned). An ideal operation is calculated and, in the event of deviations, the sector of the deviation is visualized, e.g. in a “spider image/spider diagram”.

Furthermore, in the event of deviations, further information, such as possible control levers for correction to return to ideal operation, is displayed when the sectors are selected. The visualization takes place, for example by means of existing instrumentation and control, a PC, or alternatively or additionally by means of a portable or hand-held PC or on a mobile telephone with suitable graphic support.

For example, a preview of the next 24 hours can be obtained. Longer forecasts, e.g. 1 month, are also conceivable depending on the accuracy of the available data on the influencing factors.

In this way, a process control system in accordance with the invention is also suitable as an early warning system.

Both for the control of the machine process and for business processes, the invention thus provides important information on the current position of the business under consideration or of the operating point of the machine compared to ideal operation, as a preview over the defined time period, by displaying for example a “spider” with selectable further information or instructions on possible methods of influencing, by means of which the current operating point can be guided in the direction of an optimum.

The following individual steps of a method in accordance with the invention can be contained in a form of embodiment either individually or in combination:
a. Predefined characteristic variables of an ideal (business) process that are configurable and can be evaluated by weighting and can be adapted to the particular (business) process under consideration. The characteristic variables can be acquired relative to time, i.e. are variables that can be derived from current data and enable trends to be predicted, and from this enable an ideal (business) process to be determined.
b. Determination of deviations of the current (business) operating point compared to the ideal (business) operating point on the basis of a good functional that also takes account of the change in individual functions relative to time, or their influence over time. This time-dependency and the observation period determined by definition (typically the next 24 hours; longer periods are possible but a greater imprecision has to be borne in mind) are taken into account when determining the good functional. The timing of the sampling of the input variables takes place within a defined (e.g. 15 minute) time frame.
c. Visualization of the deviation from the ideal business operating point in the form of a spider image that shows the cost variables on the coordinates. Deviation from the ideal value can be shown as % values and in the relevant national currency (e.g. z,900 ). The spider image enables two items of information to be visualized in one picture:
   the direction of the deviation and
   where there are several deviations the overall status is visualized by the size of the area in the deviation.
d. If the optimum is undershot for the factors (e.g. risk=0) this is not indicated for PTI, but instead the undershoots are cut off to compensate. Deviations from the optimum point due to over-fulfillment of a factor are nevertheless indicated as a negative variation for other factors.

By clicking, e.g. using a PC mouse, on the individual “coordinates” in the spider diagram, further information can be obtained that contains strategic data, or those control levers (influencing variables) that have to be changed in order to achieve an objective can be indicated, i.e. variables can be graphically selected and information regarding what can be done to improve the current operating point can be output (a message of this kind can, e.g. appear as “Factor “Risk”: use procedure XY (see Manual p. 123)”).

The illustration is a graphic visualization of an exemplary embodiment of the invention.

1-2. (canceled)

3. A method for controlling a process flow, comprising:
determining a plurality of ideal characteristic variables for the process flow that describe a sub-aspect of the process flow and define a desired target for each sub-aspect;
determining actual characteristic variables of the sub-aspects of the process flow at an observation time point and the actual state of the process flow in the observation time period is described by the actual characteristic variables;
determining a plurality of deviations of the actual characteristic variables from the corresponding ideal characteristic variables with the changes over time of the actual characteristic variables being included; and
representing the ideal characteristic variables as an optimum point in a center area of a display field of a visualization system and the actual characteristic variables are shown as an actual point at a distance from the optimum point and the actual points are graphically connected by connecting lines so that the area enclosed by the connecting lines is a measure of the quality of the process flow in the observation time period.

4. A device for controlling a process flow by a data processing system, comprising:
an electronic storage area where a plurality of ideal characteristic variables that describe a sub-aspect of the process flow can be stored and a desired target process flow is defined by the ideal characteristic variables;
a calculation module that determines the actual characteristic variables of the sub-aspects of the process flow in an observation time period during the process flow and an actual state of the process flow in the observation time period is described by the actual characteristic variables and the deviations of the actual characteristic variables from the corresponding ideal characteristic variables; and
a visualization system that represents the ideal characteristic variables as an optimum point in a central area of a display field of the visualization system and the actual characteristic variables are represented as an actual point at a distance from the optimum point such that the relation to the deviation of the corresponding actual characteristic variable from the corresponding ideal characteristic variable are represented as actual points being graphically connected by connecting lines to create an area enclosed by the connecting lines is a measure of the quality of the process flow in the observation time period.
